(19) United States
(12) Patent Application Publication
(10) Pub. No.: US 2024/0192989 A1
(43) Pub. Date: Jun. 13, 2024

(54) CONTAINER APPLICATION SCHEDULING METHOD AND APPARATUS, ELECTRONIC DEVICE AND STORAGE MEDIUM

(71) Applicant: SUZHOU METABRAIN INTELLIGENT TECHNOLOGY CO., LTD., Suzhou, Jiangsu (CN)

(72) Inventor: Chunting GUO, Suzhou, Jiangsu (CN)

(21) Appl. No.: 18/571,641

(22) PCT Filed: May 26, 2022
(86) PCT No.: PCT/CN2022/095378

§ 371 Date: Dec. 18, 2023

(30) Foreign Application Priority Data
Dec. 16, 2021 (CN) 202111536894.2

(51) Int. Cl. G06F 9/48; G06F 9/50

(52) U.S. Cl. CPC G06F 9/4881; G06F 9/5016

(57) ABSTRACT

A container application scheduling method and apparatus, an electronic device, and a storage medium. The method includes: acquiring image file information of a container application to be scheduled and image file cache information of all compute nodes; where the image file cache information includes local storage residual resources and cached container image layer file information of the compute nodes; determining a local storage resource requirement of the container application for each compute node according to the image file information and cached container image layer file information of each compute node; and determining, according to the local storage resource requirement and the local storage residual resources of each compute node, a target compute node configured for performing container application scheduling.

### CROSS-REFERENCE TO RELATED APPLICATION

This application claims priority to Chinese Patent Application No. 202111536894.2, filed to China National Intellectual Property Administration on Dec. 16, 2021 and entitled “Container Application Scheduling Method and Apparatus, Electronic Device and Storage Medium”, the entire content of which is hereby incorporated by reference.

### FIELD

The present application relates to the technical field of computers, in particular to a container application scheduling method and apparatus, an electronic device and a storage medium.

### BACKGROUND

Cloud Native is a distributed cloud based on distributed deployment and unified operation and management, which is a cloud technology product system established on the basis of technologies such as containers, Microservices and DevOps. At present, the usage of container-based cloud-native technologies is increasing, which brings convenience such as flexibility and elasticity to various applications. In terms of construction of a container cloud platform, how to automatically deploy container applications has become a key research content.

In the prior art, typically according to a running internal memory of each compute node, a target compute node where a running internal memory is enough to meet the container scheduling requirement is selected from these compute nodes to perform, based on the target compute node, a subsequent container scheduling operation.

However, the applicant has realized that when a compute node schedules a container, a container image needs to be cached, whereby the container might be started to perform computation at the compute node. If local storage of the node is exhausted, the compute node cannot continue to host container application scheduling even when the running internal memory is sufficient, and thus, the success rate of container application scheduling cannot be ensured.

### SUMMARY

The present application provides a container application scheduling method and apparatus, an electronic device and a storage medium.

A first aspect of the present application provides a container application scheduling method, including:
acquiring image file information of a container application to be scheduled and image file cache information of all compute nodes; where the image file cache information includes local storage residual resources and cached container image layer file information of the compute nodes;
determining a local storage resource requirement of the container application for each compute node according to the image file information and the cached container image layer file information of each compute node; and
determining, according to the local storage resource requirement and the local storage residual resources of each compute node, a target compute node configured for performing container application scheduling.

In some implementation modes, the determining a local storage resource requirement of the container application for each compute node according to the image file information and the cached container image layer file information of each compute node includes:
determining container image layer file information to be cached of each compute node according to the image file information and the cached container image layer file information of each compute node; and
determining the local storage resource requirement of the container application for each compute node according to the container image layer file information to be cached.

In some implementation modes, the determining, according to the local storage resource requirement and the local storage residual resources of each compute node, a target compute node configured for performing container application scheduling includes:
determining compute nodes where the local storage residual resources are enough to meet corresponding local storage resource requirements as candidate compute nodes, when the local storage residual resources of the compute nodes are enough to meet corresponding local storage resource requirements;
determining the priority of each candidate compute node according to the size of the corresponding local storage resource requirement of each candidate compute node; and
determining a candidate compute node with the highest priority as the target compute node.

In some implementation modes, the local storage resource requirement characterizes the total size of a container image layer file to be cached in the compute node, and the determining the priority of each candidate compute node according to the size of the corresponding local storage resource requirement of each candidate compute node includes:
determining, for each container image layer file to be cached in each candidate compute node, a ratio of the number of compute nodes where the container image layer file to be cached has been cache-hit to the total number of the compute nodes as a weighting coefficient of the container image layer file to be cached; and
determining the priority of each candidate compute node according to the size of each container image layer file to be cached in each candidate compute node and a corresponding weighting coefficient of each container image layer file to be cached.

In some implementation modes, the method further includes:
acquiring a resource request of the container application to be scheduled and internal memory resource information of each compute node; and
determining a compute node to be filtered, according to the resource request of the container application to be scheduled and the internal memory resource information of each compute node.

In some implementation modes, the method further includes:
acquiring locating information of the target compute node; and
sending the locating information to a container application management center to enable the container application management center to issue, based on the locating information, a container application scheduling task to the target compute node.

In some implementation modes, the method further includes:
determining, based on a pre-set compute node forced anti-affinity policy, the corresponding target compute node for each Pod, when a container scheduling mode of the container application to be scheduled is multi-copy Pod scheduling.

In some implementation modes, the method further includes:
determining that one target compute node executes a subsequent container application scheduling flow, when the container scheduling mode of the container application to be scheduled is single-copy Pod scheduling.

A second aspect of the present application provides a container application scheduling apparatus, including:
an acquisition module, configured for acquiring image file information of a container application to be scheduled and image file cache information of all compute nodes; where the image file cache information includes local storage residual resources and cached container image layer file information of the compute nodes;
a determination module, configured for determining a local storage resource requirement of the container application for each compute node according to the image file information and the cached container image layer file information of each compute node; and
a scheduling module, configured for determining, according to the local storage resource requirement and the local storage residual resources of each compute node, a target compute node configured for performing container application scheduling.

In some implementation modes, the determination module is configured for:
determining container image layer file information to be cached of each compute node according to the image file information and the cached container image layer file information of each compute node; and
determining the local storage resource requirement of the container application for each compute node according to the container image layer file information to be cached.

In some implementation modes, the scheduling module is configured for:
determining compute nodes where the local storage residual resources are enough to meet corresponding local storage resource requirements as candidate compute nodes, when the local storage residual resources of the compute nodes are enough to meet corresponding local storage resource requirements;
determining the priority of each candidate compute node according to the size of the corresponding local storage resource requirement of each candidate compute node; and
determining a candidate compute node with the highest priority as the target compute node.

In some implementation modes, the scheduling module is configured for:
determining, for each container image layer file to be cached in each candidate compute node, a ratio of the number of compute nodes where the container image layer file to be cached has been cache-hit to the total number of the compute nodes as a weighting coefficient of the container image layer file to be cached; and
determining the priority of each candidate compute node according to the size of each container image layer file to be cached in each candidate compute node and a corresponding weighting coefficient of each container image layer file to be cached.

In some implementation modes, the apparatus further includes:
a filtering module, configured for acquiring a resource request of a container application to be scheduled and internal memory resource information of each compute node; determining a compute node to be filtered, according to the resource request of the container application to be scheduled and the internal memory resource information of each compute node.

In some implementation modes, the scheduling module is further configured for:
acquiring locating information of the target compute node; and
sending the locating information to a container application management center to enable the container application management center to issue, based on the locating information, a container application scheduling task to the target compute node.

In some implementation modes, the scheduling module is further configured for:
determining, based on a pre-set compute node forced anti-affinity policy, the corresponding target compute node for each Pod, when a container scheduling mode of the container application to be scheduled is multi-copy Pod scheduling.

A third aspect of the present application provides an electronic device, a memory, and one or more processors, the memory storing therein computer-readable instructions that, when executed by the one or more processors, cause the one or more processors to execute the steps of the container application scheduling method according to any of the above implementation modes.

A fourth aspect of the present application provides one or more non-transitory storage media storing the computer-readable instructions that, when executed by one or more processors, cause the one or more processors to execute the steps of the container application scheduling method according to any of the above implementation modes.

The details of one or more embodiments of the present application will be set forth in the drawings and the description below. Other features and advantages of the present application will be apparent from the description and drawings, and claims.

### BRIEF DESCRIPTION OF THE DRAWINGS

In order to describe the technical solutions in the embodiments of the present application or in the prior art more clearly, the drawings needed to be used in descriptions about the embodiments or the conventional art will be simply introduced below. It is apparent that the drawings described below are some embodiments of the present application. For those of ordinary skill in the art, other drawings may also be obtained according to these drawings.

FIG. 1 is a schematic structural diagram of a container application scheduling system provided in one or more embodiments of the present application:

FIG. 2 is a flowchart of a container application scheduling method provided in one or more embodiments of the present application;

FIG. 3 is a schematic structural diagram of an exemplary container application scheduling system provided in one or more embodiments of the present application:

FIG. 4 is a schematic structural diagram of a container application scheduling apparatus provided in one or more embodiments of the present application; and

FIG. 5 is a schematic structural diagram of an electronic device provided in one or more embodiments of the present application.

Specific embodiments of the present application have been shown through the above drawings, and will be described in more details hereinafter. These drawings and text description are not intended to limit the scope of the disclosed concepts in any way, but rather to illustrate the concepts of the present application to those skilled in the art with reference to particular embodiments.

### DETAILED DESCRIPTION

In order that the objects, technical solutions and advantages of the embodiments of the present application will become more apparent, the technical solutions in the embodiments of the present application will now be described clearly and completely with reference to the drawings in the embodiments of the present application. It is obvious that the described embodiments are some, but not all, embodiments of the present application. All other embodiments obtained by a person of ordinary skill in the art based on the embodiments in the present application without making creative efforts fall within the scope of protection of the present application.

Furthermore, the terms “first”, “second” and the like are used for descriptive purposes only and cannot be construed as indicating or implying relative importance or implicitly designating the number of technical features indicated. In the description of each following embodiment, “a plurality of” means two or more, unless otherwise explicitly and in some embodiments defined.

In a container cloud platform, computing resources mainly consist of CPU internal memories of compute nodes, and the local storage of the compute nodes is not considered effectively when the resources are scheduled. In addition to hosting an operating system itself, system logs, application logs and the like, the local storage also needs to cache container images, whereby a container might be started at the node for computation. If the local storage is exhausted, even if the CPU internal memory of the node is sufficient, the node cannot continue to host container scheduling, or even a whole magnetic disc space will be exhausted and the node will be paralyzed. Current schedulers schedule the CPU internal memory under the assumption that local storage resources are sufficient, without considering the condition of a local magnetic disc. Therefore, when the container is scheduled, scheduling is prone to fail due to insufficient local storage, especially when there are compute nodes with a smaller local magnetic disc specification. With a built-in scheduling policy of Kubemetes, it might be judged according to whether there is an overall image or not that if the node caches the image, the priority is high, and the cache miss priority is low. There are two problems about such judgment: the first problem is that the situation of insufficient local magnetic disc space is not considered, and the second problem is that the judgment based on the image as granularity is relatively coarse. The container images are stored in layers, and even if the image is not present, some of layer files of the images may also be present, as different images might share underlying read-only layer files.

Aiming at the above-mentioned problems, according to a container application scheduling method and apparatus, an electronic device and a storage medium provided in the embodiments of the present application, image file information of a container application to be scheduled and image file cache information of all compute nodes are acquired; where the image file cache information includes local storage residual resources and cached container image layer file information of the compute nodes; a local storage resource requirement of the container application for each compute node is determined according to the image file information and the cached container image layer file information of each compute node; and a target compute node configured for performing container application scheduling is determined according to the local storage resource requirement and the local storage residual resources of each compute node. According to the method provided in the above-mentioned solution, the target compute node is determined according to usage situations of the local storage resources of different compute nodes in order to ensure that the target compute node might cache the overall image of the container application to be scheduled, thereby improving the success rate of container application scheduling.

The following specific embodiments might be combined with each other, and the same or similar concepts or processes may not be repeated in certain embodiments. Hereinafter, the embodiments of the present application will be described in conjunction with the drawings.

Firstly, the structure of the container application scheduling system on which the present application provided is described:

The container application scheduling method and apparatus, the electronic device and the storage medium provided in the embodiments of the present application are configured for scheduling the container application for a distributed system to implement flexible deployment of application functions. As shown in FIG. 1, it is a schematic structural diagram of a container application scheduling system on which the embodiments of the present application provided, where the container application scheduling system mainly includes a plurality of compute nodes and the container application scheduling apparatus configured for performing container application scheduling. In some embodiments, the container application scheduling apparatus acquires the image file information of the container application currently to be scheduled and the image file cache information of all the compute nodes, and then, determines, according to these pieces of information, the target compute node that might finally perform container application scheduling.

The embodiments of the present application provide a container application scheduling method, configured for scheduling the container application for the distributed system. Execution subjects of the embodiments of the present application are electronic devices, such as servers, desktop computers, notebook computers, tablet computers, and other electronic devices that may be configured for container application scheduling.

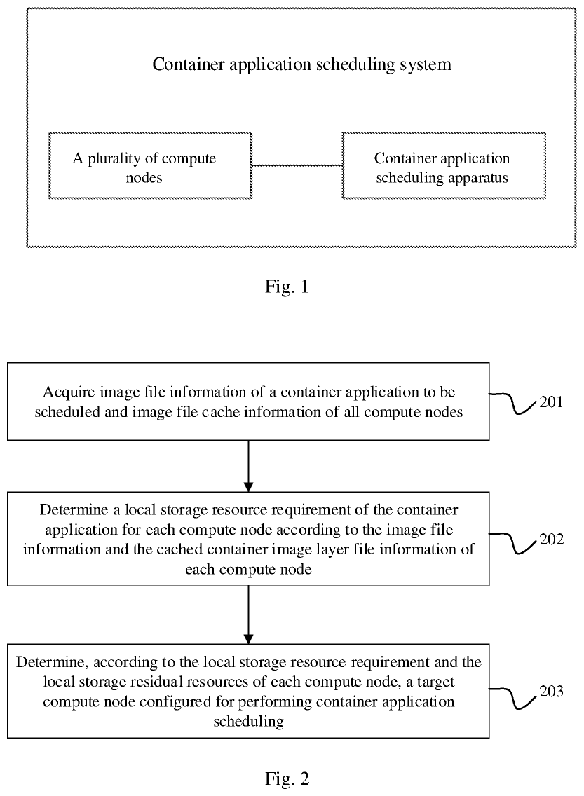

As shown in FIG. 2, it is a flowchart of a container application scheduling method provided in the embodiments of the present application, where the method includes:

Step 201: acquire the image file information of the container application to be scheduled and the image file cache information of all the compute nodes.

The image file cache information includes the local storage residual resources (residual space of the local magnetic disc) of the compute node and the cached container image layer file information.

It should be noted that the image file information includes at least an ID identifier of the image file of the container application to be scheduled and an ID identifier and size of each layer file. The ID identifier of the image file and the ID identifier of the layer file might both be obtained by performing digest computation through a preset hash algorithm, and can characterize the description content of the file.

In some embodiments, the container application scheduling method provided in the embodiments of the present application might be implemented based on a framework of a Kubernetes container orchestration engine. Therefore, the image file cache information of the compute node might be acquired based on a corresponding command of a local docker process of the compute node. The command is: docker manifest inspect name:tag.

Step 202: determine the local storage resource requirement of the container application for each compute node according to the image file information and the cached container image layer file information of each compute node.

In some embodiments, the ID identifier of the cached container image layer file of each compute node might be determined according to the cached container image layer file information of each compute node, and then the container image layer file to be cached in each compute node is determined according to the ID identifier of the cached container image layer file of each compute node and the corresponding ID identifier of each layer file of the container application to be scheduled, thereby determining the local storage resource requirement of each compute node for the container application.

In some embodiments, in an embodiment, the container image layer file information to be cached of each compute node might be determined according to the image file information and the cached container image layer file information of each compute node; and the local storage resource requirement of the container application for each compute node is determined according to the container image layer file information to be cached.

The container image layer file information to be cached may be the ID identifier of the container image layer file to be cached, and then, the total size of all the container image layer files to be cached is computed for each compute node according to the ID identifier of the container image layer file to be cached and the ID identifier and size of each layer file (container image layer file) recorded in the image file information. The local storage resource requirement of the container application for the compute node is equal to the total size of all the container image layer files to be cached in the compute node.

Exemplarily, the total size of all the container image layer files to be cached in the compute node might be determined according to the following formula:

Total_size=image1_layerX_size+image1_layerY_size+ . . . +imageN_layerX_size+imageN_layerY_size
where Total_size represents the total size of all the container image layer files to be cached, image1_layerX_size and image1_layerY_size represent the size of a layer file (container image layer file to be cached) that a container image image1 is not cached in the compute node, and similarly, imageN_layerX_size and imageN_layerY_size are the size of a layer file that imageN is not cached in the compute node.

Step 203: determine, according to the local storage resource requirement and the local storage residual resources of each compute node, the target compute node configured for performing container application scheduling.

In some embodiments, by comparing a size relationship between the local storage resource requirement and the local storage residual resources of each compute node, it might be judged whether each compute node might cache the overall image of the container application to be scheduled or not, thereby determining the target compute node that might be configured for performing container application scheduling.

On the basis of the above-mentioned embodiments, since there are generally a large number of compute nodes, a compute node that might cache the overall image of the container application to be scheduled is generally not unique. In order to improve the scheduling efficiency of the container application, as an implementable mode, in an embodiment, the determining, according to the local storage resource requirement and the local storage residual resources of each compute node, a target compute node configured for performing container application scheduling includes:

Step 2031: judge whether the local storage residual resources of each compute node are enough to meet the corresponding local storage resource requirements or not;

Step 2032: determine the compute nodes where the local storage residual resources are enough to meet the corresponding local storage resource requirements as candidate compute nodes;

Step 2033: determine the priority of each candidate compute node according to the size of the corresponding local storage resource requirement of each candidate compute node; and

Step 2034: determine a candidate compute node with the highest priority as the target compute node.

In some embodiments, it is judged whether the local storage residual resources of each compute node are enough to meet the corresponding local storage resource requirements or not. If it is judged that the local storage residual resources of the compute node are enough to meet the corresponding local storage resource requirements, based on this judgment result, the compute nodes where the local storage residual resources are enough to meet the corresponding local storage resource requirements as the candidate compute nodes.

In some embodiments, the compute nodes that might cache the overall image of the container application to be scheduled may be determined as the candidate compute nodes, and then the priority of each candidate compute node is determined according to the total size (local storage resource requirements) of the container image layer file to be cached in each candidate node. The lower the local storage resource requirement is, the higher the corresponding priority thereof is, that is, the candidate compute node with a minimum local storage resource requirement (highest priority) might be determined as the target compute node.

The fewer container image layer files that the target compute node needs to pull, the higher the pulling efficiency. Therefore, this target compute node is beneficial for improving the scheduling efficiency of the container application.

In some embodiments, in an embodiment, in order to avoid the occurrence of a hotspot compute node, and also in order to ensure compute node load balance, for each container image layer file to be cached in each candidate compute node, the ratio of the number of the compute nodes where the container image layer file to be cached has been cache-hit to the total number of the compute nodes might be determined as the weighting coefficient of the container image layer file to be cached; the priority of each candidate compute node is determined according to the size of each container image layer file to be cached in each candidate compute node and a corresponding weighting coefficient of each container image layer file to be cached.

The compute node where cache-hit in some embodiments refers to a compute node where the cached container image layer file includes a container image layer file to be cached in another compute node.

In some embodiments, a priority index of each candidate compute node might be computed according to the following formula:

score=image1_layerX_size*nodeNum/totalNodeNum+ . . . +imageN_layerY_size *nodeNum/totalNodeNum
where score represents the priority index, image1_layerX_size represents the size of one container image layer file to be cached in the candidate compute node, nodeNum represents the number of compute nodes where the container image layer file (such as image1_layerX) has been cache-hit, and totalNodeNum represents the total number of the compute nodes.

In some embodiments, the larger the priority index score, the higher the corresponding priority, that is, the candidate compute node with the largest priority index score might be determined as the target compute node. The higher the weighting coefficient (the ratio of the number of the compute nodes where the container image layer file to be cached has been cache-hit to the total number of the compute nodes), the lower the corresponding hotness, and the larger the obtained priority index score, thereby achieving the effect of avoiding the occurrence of the hotspot compute node.

On the basis of the above-mentioned embodiments, in order to further ensure the success rate of container application scheduling, as an implementable mode, in an embodiment, the method further includes:

Step 301: acquire a resource request of the container application to be scheduled and internal memory resource information of each compute node; and

Step 302: determine compute nodes to be filtered, according to the resource request of the container application to be scheduled and the internal memory resource information of each compute node.

In some embodiments, compute nodes (compute nodes to be filtered) that does not meet internal memory resources and device characteristics might be filtered by employing an existing filter filtering algorithm of Kubernetes firstly according to a resource request (the resource request of the container application to be scheduled) issued by a user.

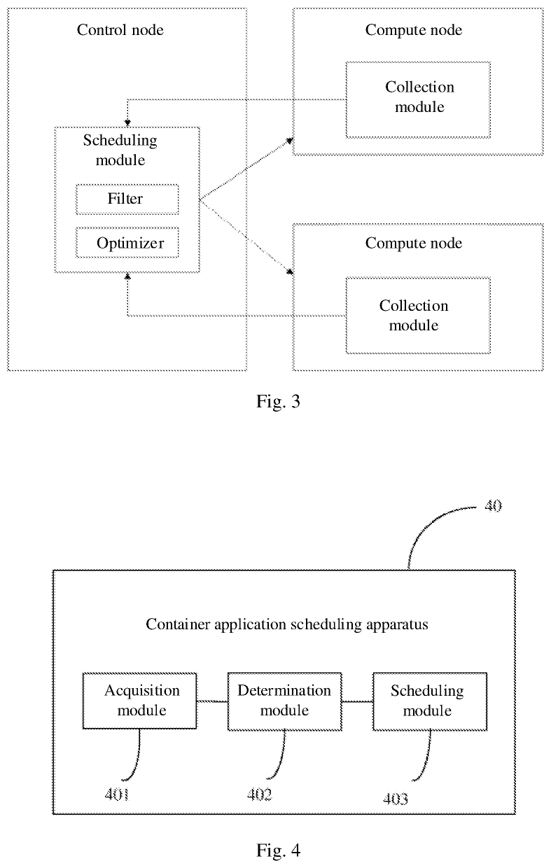

Exemplarily, as shown in FIG. 3, it is a schematic structural diagram of an exemplary container application scheduling system provided in an embodiment of the present application, and the distributed system applied by the embodiment of the present application includes a control node and a compute node, where the control node is configured for controlling the compute node in the system, and the compute node is configured for hosting a computing task. Each compute node includes a collection module, configured for collecting internal memory resource information and image file cache information of a corresponding compute node, and sending these pieces of collected information to a scheduling module, and the scheduling module might select, according to the received information, a target compute node configured for performing container application scheduling from these compute nodes. The control node includes a scheduling module configured for scheduling the container application. The scheduling module includes a filter and an optimizer, where the filter is configured for filtering out compute nodes where internal memory resources and local storage resources cannot meet container application scheduling requirements, and the optimizer is configured for selecting a target compute node from filtered compute nodes (candidate compute nodes).

In some embodiments, in an embodiment, after the target compute node is determined, locating information of the target compute node might be acquired; the locating information is sent to a container application management center to enable the container application management center to issue, based on the locating information, a container application scheduling task to the target compute node.

The locating information of the target compute node may include a name, an IP address and the like of the target compute node.

In some embodiments, the locating information of the target compute node might be stored to a database of Kubernetes to enable the container application management center to locate the target compute node according to the locating information for subsequent other modules to perform subsequent scheduling flows.

In some embodiments, in an embodiment, it might also be judged whether a container scheduling mode of the container application to be scheduled is multi-copy Pod scheduling or not; if yes, the corresponding target compute node is determined for each Pod, based on a pre-set compute node forced anti-affinity policy.

In some embodiments, it might also be judged whether the container scheduling mode of the container application to be scheduled is multi-copy Pod scheduling or not. When it is judged that the container scheduling mode of the container application to be scheduled is multi-copy Pod scheduling, based on this judgment result, the corresponding target compute node is determined for each Pod, based on the pre-set compute node forced anti-affinity policy.

In Kubernetes, starting is performed in units of Pod, and Pod is a container set. Therefore, a scheduling will include a plurality of container images.

In some embodiments, for the container application where the container scheduling mode the multi-copy Pod scheduling, in order to guarantee high availability, same compute node scheduling should be avoided. Therefore, the compute node forced anti-affinity policy might be used in conjunction. A determination flow of the target compute node of each Pod may refer to the above-mentioned embodiments.

Conversely, in an embodiment, if the container scheduling mode of the container application to be scheduled is single-copy Pod scheduling, a target compute node might be determined directly based on the above-mentioned embodiments to perform subsequent container application scheduling flows.

In some embodiments, in the present application, it might be judged whether the container scheduling mode of the container application to be scheduled is multi-copy Pod scheduling or not. When it is judged that the container scheduling mode of the container application to be scheduled is single-copy Pod scheduling, based on this judgment result, one target compute node might be determined directly based on the above-mentioned embodiments to perform the subsequent container application scheduling flows.

According to the container application scheduling method provided in the embodiments of the present application, the image file information of the container application to be scheduled and the image file cache information of all the compute nodes are acquired; where the image file cache information includes the local storage residual resources and the cached container image layer file information of the compute nodes; the local storage resource requirement of the container application for each compute node is determined according to the image file information and the cached container image layer file information of each compute node; and the target compute node configured for performing container application scheduling is determined according to the local storage resource requirement and the local storage residual resources of each compute node. According to the method provided in the above-mentioned solution, the target compute node is determined according to usage situations of the local storage resources of different compute nodes in order to ensure that the target compute node might cache the overall image of the container application to be scheduled, thereby improving the success rate of container application scheduling. Moreover, files cache-hit in the compute node is performed based on the container image layer file, rather than the entire container image, and thus, the cache-hit rate might be computed more accurately. Moreover, the local storage resources might be saved, the network overhead of pulling images might be reduced, the container scheduling efficiency might be improved, and the resource utilization might be improved.

The embodiments of the present application provide a container application scheduling apparatus, configured for executing the container application scheduling method provided in the above-mentioned embodiments.

As shown in FIG. 4, it is a schematic structural diagram of a container application scheduling apparatus provided in the embodiments of the present application. The container application scheduling apparatus 40 includes: an acquisition module 401, a determination module 402 and a scheduling module 403.

The acquisition module is configured for acquiring the image file information of the container application to be scheduled and the image file cache information of all the compute nodes; where the image file cache information includes the local storage residual resources and the cached container image layer file information of the compute nodes; the determination module is configured for determining the local storage resource requirement of the container application for each compute node according to the image file information and the cached container image layer file information of each compute node; and the scheduling module is configured for determining, according to the local storage resource requirement and the local storage residual resources of each compute node, the target compute node configured for performing container application scheduling.

In some embodiments, in an embodiment, the determination module is in some embodiments configured for:
determining the container image layer file information to be cached of each compute node according to the image file information and the cached container image layer file information of each compute node;
determining the local storage resource requirement of the container application for each compute node according to the container image layer file information to be cached.

In some embodiments, in an embodiment, the scheduling module is in some embodiments configured for
judging whether the local storage residual resources of each compute node are enough to meet the corresponding local storage resource requirements or not;
determining the compute nodes where the local storage residual resources are enough to meet the corresponding local storage resource requirements as the candidate compute nodes;
determining the priority of each candidate compute node according to the size of the corresponding local storage resource requirement of each candidate compute node; and
determining a candidate compute node with the highest priority as the target compute node.

In some embodiments, in an embodiment, the scheduling module is in some embodiments configured for:
determining, for each container image layer file to be cached in each candidate compute node, a ratio of the number of compute nodes where the container image layer file to be cached has been cache-hit to the total number of the compute nodes as a weighting coefficient of the container image layer file to be cached;
determining the priority of each candidate compute node according to the size of each container image layer file to be cached in each candidate compute node and a corresponding weighting coefficient of each container image layer file to be cached.

In some embodiments, in an embodiment, the container application scheduling apparatus further includes:
a filtering module, configured for acquiring a resource request of a container application to be scheduled and internal memory resource information of each compute node; determining a compute node to be filtered, according to the resource request of the container application to be scheduled and the internal memory resource information of each compute node.

In some embodiments, in an embodiment, the scheduling module is further configured for:
acquiring the locating information of the target compute node;
sending the locating information to a container application management center to enable the container application management center to issue, based on the locating information, a container application scheduling task to the target compute node.

In some embodiments, in an embodiment, the scheduling module is further configured for:
judging whether the container scheduling mode of the container application to be scheduled is multi-copy Pod scheduling or not; and
if yes, determining, based on a pre-set compute node forced anti-affinity policy, the corresponding target compute node for each Pod.

With respect to the container application scheduling apparatus in this embodiment, the specific way in which various modules execute operations has been described in details with respect to the embodiments of the method, which will not be described in details here.

The container application scheduling apparatus provided in the embodiments of the present application is configured for executing the container application scheduling method provided in the above-mentioned embodiment, and its implementation mode and principle are same, which will not be repeated.

The embodiments of the present application provide an electronic device, configured for executing the container application scheduling method provided in the above-mentioned embodiments.

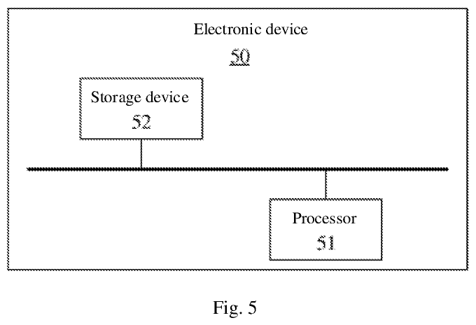

As shown in FIG. 5, it is a schematic structural diagram of an electronic device provided in the embodiments of the present application. The electronic device 50 includes: at least one processor 51 and a storage device 52. The memory stores therein computer-readable instructions that, when executed by one or more processors, cause the one or more processors to execute the container application scheduling method as provided in the above-mentioned embodiments.

The embodiments of the present application provide an electronic device, configured for executing the container application scheduling method provided in the above-mentioned embodiments, and its implementation mode and principle are same, which will not be repeated.

The embodiments of the present application further provide one or more non-transitory storage media storing computer-readable instructions that, when executed by one or more processors, cause the one or more processors to execute the container application scheduling method as provided in any of the above-mentioned embodiments.

The storage medium including the computer-executable instructions of the embodiments of the present application might be configured for storing the computer-executable instructions of the container application scheduling method provided in the aforementioned embodiments, and its implementation mode and principle are same, which will not be repeated.

In several embodiments provided in the present application, it should be understood that the disclosed apparatus and method may be implemented in other ways. For example, the apparatus embodiments described above are merely illustrative. For example, the division of units is merely a logical function division, and there may be additional division ways in actual implementation. For example, a plurality of units or assemblies might be combined or integrated into another system, or some features may be omitted, or not executed. In another aspect, the displayed or discussed mutual couplings or direct couplings or communication connections may be implemented by using some interfaces. The indirect couplings or communication connections between the apparatuses or units might be implemented in electronic, mechanical or other forms.

The units described as separate components may be or may not be physically separated, and the components displayed as units may be or may not be physical units, that is, they might be located in one place, or they might be distributed onto a plurality of network units. Some or all of the units might be selected according to the actual needs to achieve the purpose of this embodiment solution.

In addition, all functional units in each embodiment of the present application might be integrated into one processing unit, or all the units might be present physically alone, or two or more units might be integrated into one unit. The above-mentioned integrated units might be implemented either in the form of hardware or in the form of hardware plus software functional units.

The above-mentioned integrated unit implemented in the form of the software functional units might be stored in a computer-readable storage medium. The above-mentioned software functional units are stored in a storage medium, including several instructions for causing a computer device (which may be a personal computer, a server, a network device or the like) or a processor to execute some of the steps of the method of each embodiment of the present application. The aforementioned memory medium includes: a USB flash disk, an external hard drive, a read-only memory (ROM), a random access memory (RAM), a magnetic disk, or an optical disc, and various other media that might store program codes.

Those skilled in the art might clearly understood that for the convenience and brevity of description, only the division of the above-mentioned functional modules is exemplified. In practical application, the above-mentioned functions might be allocated to and completed by different functional modules as needed. That is, an internal structure of the apparatus is divided into different functional modules to complete all or some of the functions described above. The detailed operation process of the apparatus described above may be referred to a corresponding process in the aforementioned method embodiments, which will not be repeated here.

Finally, it should be noted that the above-mentioned embodiments are merely illustrative of the technical solution of the present application, and do not limit the same. While the present application has been described in detail with reference to the foregoing embodiments, those skilled in the art should understand that modifications might still be made to the technical solutions recorded in the above-mentioned embodiments, or equivalent substitutions might be made to some or all of the technical features, and these modifications or substitutions do not make the essence of the corresponding technical solution depart from the scope of the technical solution of each embodiment of the present application.

1. A container application scheduling method, comprising:
acquiring image file information of a container application to be scheduled and image file cache information of a plurality of compute nodes; wherein the image file cache information comprises local storage residual resources and cached container image layer file information of the plurality of compute nodes;
determining a local storage resource requirement of the container application for each of the plurality of compute nodes according to the image file information and the cached container image layer file information of each compute node of the plurality of compute nodes; and
determining, according to the local storage resource requirement and the local storage residual resources of each compute node of the plurality of compute nodes, a target compute node configured for performing container application scheduling.

2. The method according to claim 1, wherein the determining a local storage resource requirement of the container application for each of the plurality of compute nodes according to the image file information and the cached container image layer file information of each compute node of the plurality of compute nodes comprises:
determining container image layer file information to be cached of each compute node of the plurality of compute nodes according to the image file information and the cached container image layer file information of each compute node of the plurality of compute nodes; and
determining the local storage resource requirement of the container application for each of the plurality of compute nodes according to the container image layer file information to be cached.

3. The method according to claim 1, wherein the determining, according to the local storage resource requirement and the local storage residual resources of each compute node of the plurality of compute nodes, a target compute node configured for performing container application scheduling comprises:
determining compute nodes where the local storage residual resources are enough to meet corresponding local storage resource requirements as candidate compute nodes, when the local storage residual resources of the compute node are enough to meet the corresponding local storage resource requirements;
determining a priority of each candidate compute node of the candidate compute nodes according to a size of the corresponding local storage resource requirement of each candidate compute node of the candidate compute nodes; and
determining a candidate compute node with a highest priority as the target compute node.

4. The method according to claim 3, wherein the local storage resource requirement characterizes a total size of a container image layer file to be cached in a compute node of the plurality of compute nodes, and the determining a priority of each candidate compute node of the candidate compute nodes according to a size of the corresponding local storage resource requirement of each candidate compute node of the candidate compute nodes comprises:
determining, for each container image layer file to be cached in each candidate compute node of the candidate compute nodes, a ratio of a number of compute nodes where the container image layer file to be cached has been cache-hit to a total number of the plurality of compute nodes as a weighting coefficient of the container image layer file to be cached; and
determining the priority of each candidate compute node of the candidate compute nodes according to a size of each container image layer file to be cached in each candidate compute node of the candidate compute nodes and the respective weighting coefficient of each container image layer file to be cached.

5. The method according to claim 1, further comprising:
acquiring a resource request of the container application to be scheduled and internal memory resource information of each compute node of the plurality of compute nodes; and
determining, according to the resource request of the container application to be scheduled and the internal memory resource information of each compute node, a compute node to be filtered.

6. The method according to claim 1, further comprising:
acquiring locating information of the target compute node; and
sending the locating information to a container application management center to enable the container application management center to issue, based on the locating information, a container application scheduling task to the target compute node.

7. The method according to claim 1, by further comprising:
determining, based on a pre-set compute node forced anti-affinity policy, corresponding target compute node for each Pod when a container scheduling mode of the container application to be scheduled is multi-copy Pod scheduling.

8. The method according to claim 7, further comprising:
determining that one target compute node executes a subsequent container application scheduling flow when the container scheduling mode of the container application to be scheduled is single-copy Pod scheduling.

9. (canceled)

10. An electronic device, comprising a storage device and one or more processors, the storage device storing therein computer-readable instructions that, when executed by the one or more processors, cause the one or more processors to perform operations comprising:
acquiring image file information of a container application to be scheduled and image file cache information of a plurality of compute nodes; wherein the image file cache information comprises local storage residual resources and cached container image layer file information of the plurality of compute nodes;
determining a local storage resource requirement of the container application for each of the plurality of compute nodes according to the image file information and the cached container image laver file information of each compute node of the plurality of compute nodes; and
determining, according to the local storage resource requirement and the local storage residual resources of each compute node of the plurality of compute nodes, a target compute node configured for performing container application scheduling.

11. One or more non-transitory computer-readable storage media storing computer-readable instructions, wherein the computer-readable instructions, when executed by one or more processors, cause the one or more processors to perform operations comprising:
acquiring image file information of a container application to be scheduled and image file cache information of a plurality of compute nodes; wherein the image file cache information comprises local storage residual resources and cached container image layer file information of the plurality of compute nodes;
determining a local storage resource requirement of the container application for each of the plurality of compute nodes according to the image file information and the cached container image layer file information of each compute node of the plurality of compute nodes; and
determining, according to the local storage resource requirement and the local storage residual resources of each compute node of the plurality of compute nodes, a target compute node configured for performing container application scheduling.

12. The method according to claim 1, wherein the image file information comprises at least an identification (ID) identifier of an image file of the container application to be scheduled and an ID identifier and a size of each container image layer file.

13. The method according to claim 12, further comprising:
obtaining the ID identifier of the image file and the ID identifier of each container image layer file by performing digest computation through a preset hash algorithm.

14. The method according to claim 2, wherein the container image layer file information to be cached comprises an identification (ID) identifier of a container image layer file to be cached, and the determining a local storage resource requirement of the container application for each of the plurality of compute nodes according to the image file information and the cached container image layer file information of each compute node of the plurality of compute nodes comprises:
computing a total size of container image layer files to be cached for each compute node of the plurality of compute nodes according to the image file information and the ID identifier and a size of the container image layer file to be cached; and
determining the local storage resource requirement according to the total size of the container image layer files to be cached for each compute node of the plurality of compute nodes.

15. The method according to claim 4, further comprising:
in response to an increase in the weighting coefficient, increasing a score of the priority.

16. The electronic device according to claim 10, wherein the computer-readable instructions, when executed by the one or more processors, cause the one or more processors to perform operations further comprising:
determining container image layer file information to be cached of each compute node of the plurality of compute nodes according to the image file information and the cached container image layer file information of each compute node of the plurality of compute nodes; and
determining the local storage resource requirement of the container application for each of the plurality of compute nodes according to the container image layer file information to be cached.

17. The electronic device according to claim 10, wherein the computer-readable instructions, when executed by the one or more processors, cause the one or more processors to perform operations further comprising:
determining compute nodes where the local storage residual resources are enough to meet corresponding local storage resource requirements as candidate compute nodes, when the local storage residual resources of the compute node are enough to meet the corresponding local storage resource requirements;
determining a priority of each candidate compute node of the candidate compute nodes according to a size of the corresponding local storage resource requirement of each candidate compute node of the candidate compute nodes; and
determining a candidate compute node with a highest priority as the target compute node.

18. The electronic device according to claim 17, wherein the local storage resource requirement characterizes a total size of a container image layer file to be cached in a compute node of the plurality of compute nodes, and the computer-readable instructions, when executed by the one or more processors, cause the one or more processors to perform operations further comprising:
determining, for each container image layer file to be cached in each candidate compute node of the candidate compute nodes, a ratio of a number of compute nodes where the container image layer file to be cached has been cache-hit to a total number of the plurality of compute nodes as a weighting coefficient of the container image layer file to be cached; and
determining the priority of each candidate compute node of the candidate compute nodes according to a size of each container image layer file to be cached in each candidate compute node of the candidate compute nodes and a respective weighting coefficient of each container image layer file to be cached.

19. The one or more non-transitory computer-readable storage media according to claim 11, wherein the computer-readable instructions, when executed by the one or more processors, cause the one or more processors to perform operations further comprising:
determining container image layer file information to be cached of each compute node of the plurality of compute nodes according to the image file information and the cached container image layer file information of each compute node of the plurality of compute nodes; and
determining the local storage resource requirement of the container application for each of the plurality of compute nodes according to the container image layer file information to be cached.

20. The one or more non-transitory computer-readable storage media according to claim 11, wherein the computer-readable instructions, when executed by the one or more processors, cause the one or more processors to perform operations further comprising:
determining compute nodes where the local storage residual resources are enough to meet corresponding local storage resource requirements as candidate compute nodes, when the local storage residual resources of the compute node are enough to meet the corresponding local storage resource requirements;
determining a priority of each candidate compute node of the candidate compute nodes according to a size of the corresponding local storage resource requirement of each candidate compute node of the candidate compute nodes; and
determining a candidate compute node with a highest priority as the target compute node.

21. The one or more non-transitory computer-readable storage media according to claim 20, wherein the local storage resource requirement characterizes a total size of a container image layer file to be cached in a compute node of the plurality of compute nodes, and wherein the computer-readable instructions, when executed by the one or more processors, cause the one or more processors to perform operations further comprising:
determining, for each container image layer file to be cached in each candidate compute node of the candidate compute nodes, a ratio of a number of compute nodes where the container image layer file to be cached has been cache-hit to a total number of the plurality of compute nodes as a weighting coefficient of the container image layer file to be cached; and
determining the priority of each candidate compute node of the candidate compute nodes according to a size of each container image layer file to be cached in each candidate compute node of the candidate compute nodes and a respective weighting coefficient of each container image layer file to be cached.
